(19) United States
(12) Patent Application Publication
(10) Pub. No.: US 2010/0044389 A1
(43) Pub. Date: Feb. 25, 2010

(54) RESILIENT CONTAINER GRIP DEVICE AND RELATED METHODS

(75) Inventor: Brian LOGUE, Charlotte, NC (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: TBS Products, Inc., Gainesville, GA (US)

(21) Appl. No.: 12/414,192

(22) Filed: Mar. 30, 2009

Related U.S. Application Data
(60) Provisional application No. 61/090,466, filed on Aug. 20, 2008.

(51) Int. Cl. B65D 25/28; B29C 37/00

(52) U.S. Cl. 220/752; 264/340

(57) ABSTRACT

A grip device may be useable on a top or bottom portion of a container having a larger top than bottom portion. The grip device, when positioned on the bottom portion of the container, may reduce slipping with an adjacent surface and, when positioned on the top portion of the container, may facilitate stacking of containers. The grip device may include a body of resilient material. The body of resilient material may include a grip base including spaced apart inner and outer base portions defining a slotted base opening therebetween being sized to resiliently engage the top portion of the container, an outer wall extending upwardly from the outer base portion, and an inner wall extending upwardly from the inner base portion and joining with the outer wall adjacent upper ends thereof. The inner wall may define an opening to resiliently engage the bottom portion of the container.

### RELATED APPLICATION

The present application is based upon previously filed copending provisional application Ser. No. 61/090,466, filed Aug. 20, 2008, the entire subject matter of which is incorporated by reference in its entirety.

### FIELD OF THE INVENTION

The present invention relates to the field of gripping devices, and, more particularly, to a gripping device for a container.

### BACKGROUND OF THE INVENTION

A container may have a variety of uses. For example, a container may be used to carry dry materials, for example, building supplies. A container may also be used to carry or store a liquid material. Containers may have different sizes and shapes. For example, a five-gallon bucket is a typical container for selling and storing a liquid, for example, paint.

A widely-used five-gallon bucket has a relatively standard size. For example, a five-gallon bucket may measure approximately fifteen inches tall with a lower outer diameter of about 10 inches, and an upper outer diameter of about 11.5 inches.

A typical five-gallon bucket includes two or three reinforcement collars that are located near the top. A wire or plastic handle is usually attached to the top to facilitate carrying or dumping of contents of the five-gallon bucket. A five-gallon bucket, because of its tapered sidewall, is able to nest in another five-gallon bucket for storage. Alternatively, a five-gallon bucket is stackable on another five-gallon bucket when a lid is coupled to the five-gallon bucket.

A container, such as a five-gallon bucket is typically made of plastic (polyethylene). Plastic containers may have more uses due to the popularity of plastic for food products, for example, and the tendency of a metal container to rust. A plastic container, such as a five-gallon bucket, may also be more durable than another container material. Most five-gallon buckets include 70 and 90 mil plastic densities. A 70 mil five-gallon bucket is thinner than a 90 mil bucket and is generally tapered on the bottom. A 90 mil bucket is thicker and is used in most commercial applications, including roofing, paiting, and boating, for example.

However, a plastic five-gallon bucket, like many plastic containers, may slide or tip, for example, on a wet surface, when stacked upon another plastic container, or in certain environments, such as in a marine environment, for example.

Several grip devices to be removably secured to the bottom of a container have been used. For example, such grip devices may include a continuous grip device positioned on the bottom of a bucket, pail, cup, or other similar container, wherein the base is constructed of rubber or other similar material. For example, U.S. Pat. No. 1,922,127 to Foley; U.S. Pat. No. 1,959,262 to Colabrese; U.S. Pat. No. 1,985,558 to Alexander; U.S. Pat. No. 2,060,463 to Gessler; U.S. Pat. No. 2,683,579 to Wallace; U.S. Pat. No. 2,936,926 to Miller; and U.S. Pat. No. 3,419,240 to Santic; all disclose gripping devices for attachment to the bottom of a container.

Other references disclose a grip device in the form of a ring with a central opening therein. For example, U.S. Pat. No. 511,617 to Howard; U.S. Pat. No. 5,056,749 to Ige; U.S. Pat. No. 4,253,630 to Rigg; and U.S. Pat. No. 6,152,018 to Yeh all disclose a grip device in the form of a ring with a central opening therein.

U.S. Pat. No. 3,606,074 to Hayes discloses a gripping lid that may be placed on an open container top. The gripping lid may also be used as a loose-fitting coaster for a beverage glass or container.

### SUMMARY OF THE INVENTION

In view of the foregoing background, it is therefore an object of the present invention to provide a gripping device for reduced slipping of a container.

This and other objects, features, and advantages in accordance with the present invention are provided by a container grip device useable on a top or bottom portion of a container having a larger top than bottom portion. The grip device, when positioned on the bottom portion of the container, may reduce slipping with an adjacent surface and, when positioned on the top portion of the container, may facilitate stacking of containers. The grip device may include a body of resilient material. The body of resilient material may include a grip base including spaced apart inner and outer base portions defining a slotted base opening therebetween being sized to resiliently engage the top portion of the container. The body of resilient material may also include an outer wall extending upwardly from the outer base portion, and an inner wall extending upwardly from the inner base portion and joining with the outer wall adjacent upper ends thereof. The inner wall may define an opening to resiliently engage the bottom portion of the container, for example. Accordingly, the grip device when positioned on the bottom portion of the container, reduces slipping with an adjacent surface and, when positioned on the top portion of the container, facilitates stacking of containers.

The body of resilient material may include a monolithically formed body of resilient material. The outer base portion may extend downwardly beyond the inner base portion from the upper portion of the grip device. The inner base portion may include a radially inwardly extending lip to engage the container bottom portion. The outer base portion may include a radially inwardly extending lip for engaging the container top portion, for example.

A handle may be coupled to the outer base portion to facilitate dumping of contents of the container. The inner wall may have a radial notch defined therein at the upper end thereof, for example. The grip device may further include a plurality of gripping features on the outer base portion.

Another aspect is directed to a method of making a grip device useable on a top or bottom portion of a container having a larger top than bottom portion. The grip device, when positioned on the bottom portion of the container, may reduce slipping with an adjacent surface and, when positioned on the top portion of the container, may facilitate stacking of containers, for example. The method may also include forming a body of resilient material and includes forming a grip base including spaced apart inner and outer base portions to define a slotted base opening therebetween being sized to resiliently engage the top portion of the container, for example. The method may further include forming an outer wall extending upwardly from the outer base portion, and forming an inner wall extending upwardly from the inner base portion to join with the outer wall adjacent upper ends thereof. The inner wall may be formed to define an opening to resiliently engage the bottom portion of the container.

### BRIEF DESCRIPTION OF THE DRAWINGS

FIG. 1 is a side elevation view of a bucket including a grip device in accordance with the present invention.

FIG. 2 is a greatly enlarged cross-sectional view of a portion of the grip device of FIG. 1.

FIG. 3 is a top elevation view of a portion of the grip device of FIG. 1.

FIG. 4 is a bottom elevation view of a portion of the grip device in FIG. 1.

FIG. 5 is a side elevation view of a portion of two buckets coupled together with the grip device in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

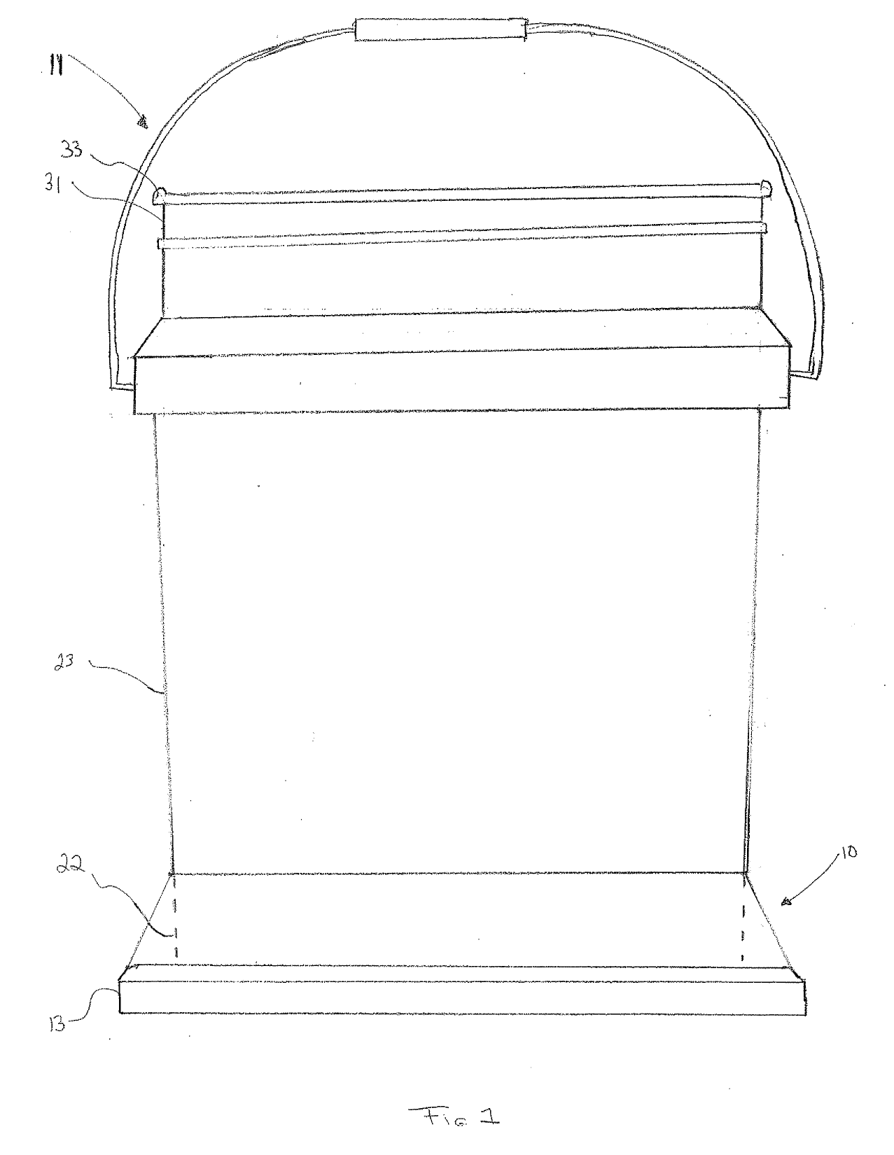

Referring initially to FIG. 1, a grip device 10 includes a body of resilient material positioned onto the bottom portion 22 of a container 11, such as a five-gallon bucket, for example, having a larger top portion 31 than bottom portion. The grip device 10 advantageously reduces slipping of the container 11, such as when positioned on a supporting surface 35 that is inclined or movable, such as a moving boat deck, for example. Other size and shape containers, buckets, and carrying devices may be used. The resilient material body of the grip device 10 may be made of a soft rubber. Other grip material may be used, for example, silicone, or a plastic compound made by compression molding, plastic extrusion, infusion molding, and/or injection molding. In some advantageous embodiments, the resilient material body may be monolithically formed.

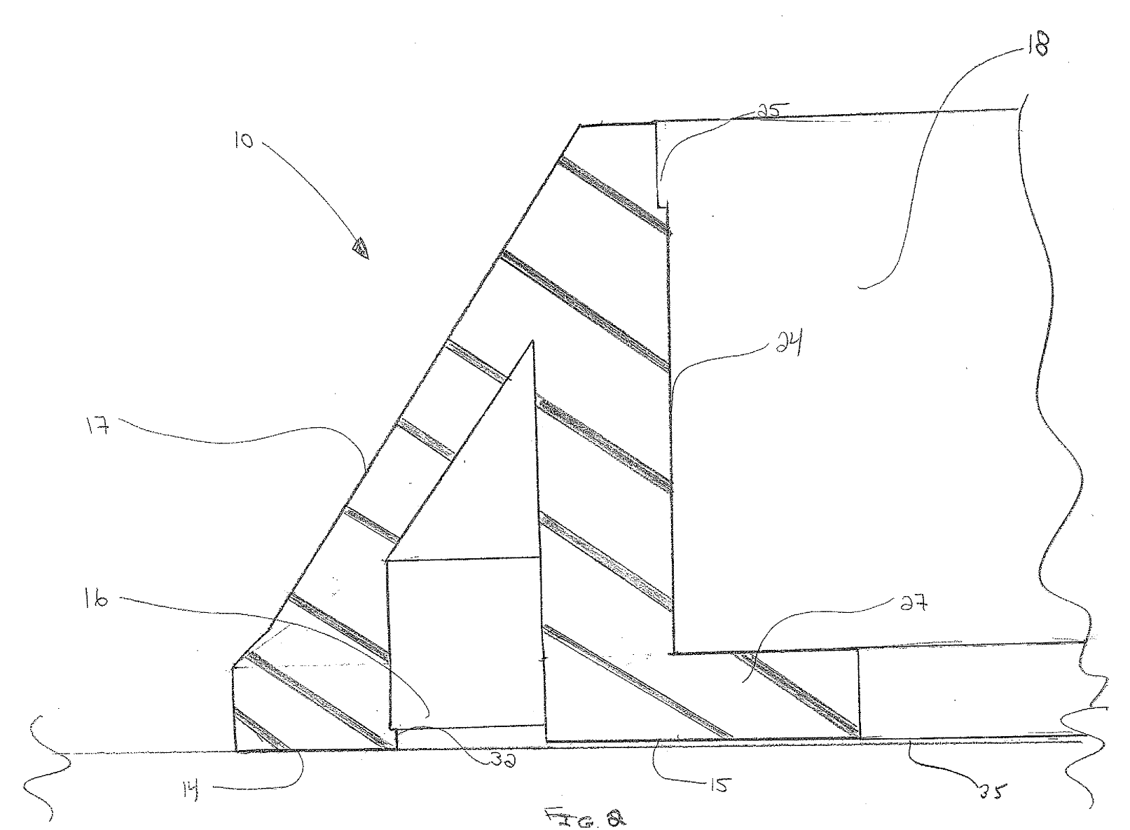

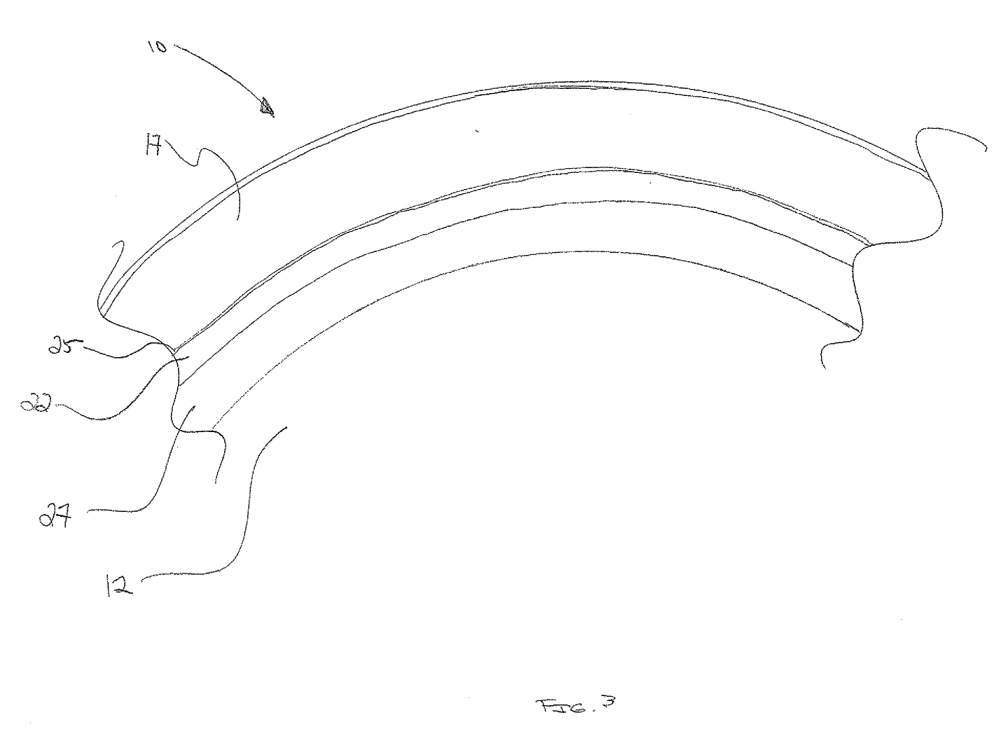

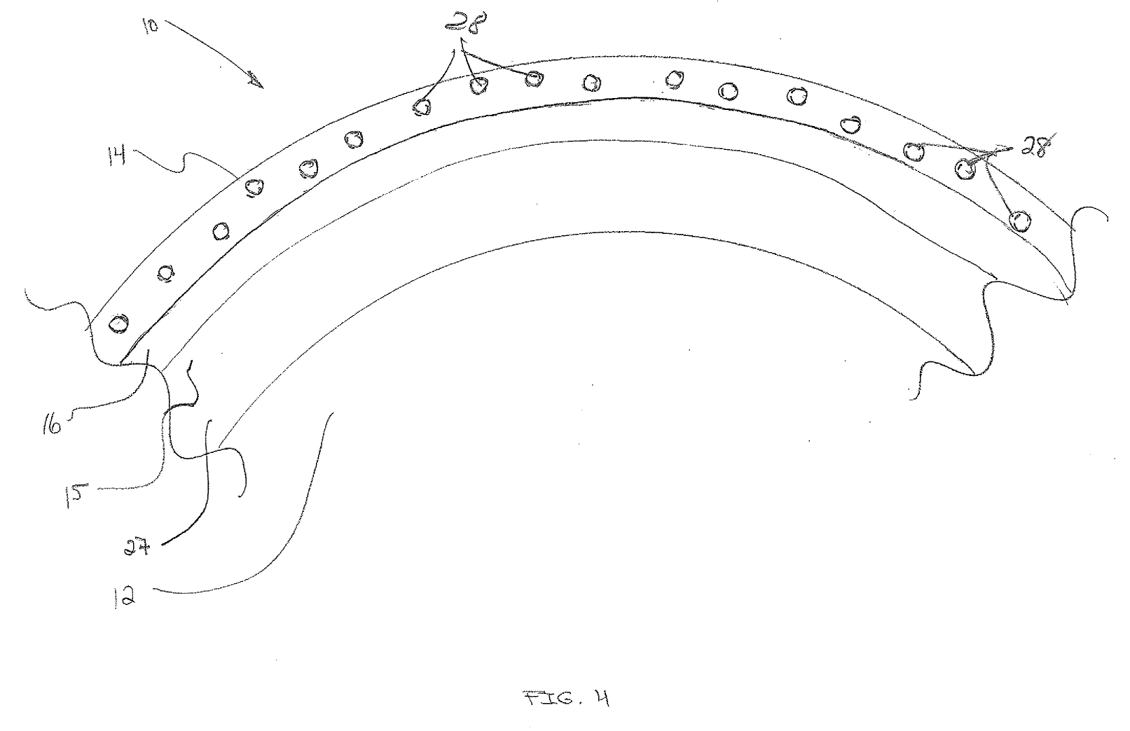

Referring additionally to FIGS. 2-4, the grip device 10 is illustratively circular in shape and has a central opening 12 therein. Other shapes and sizes may be used to accommodate different shape and size containers, and the illustrated central base opening 12 need not be included.

The grip device 10 also includes an outer base portion 14 and an inner base portion 15. The inner base portion 15 is circumferentially stretched or expanded larger than the container bottom portion 22 when engaged on the container to tightly grip the container. A slotted base opening 16 illustratively separates the inner base portion 15 from the outer base portion 14. An outer wall 17 is illustratively vertically angled and extends upwardly from the outer base portion 14. The outer wall 17 is angled to provide increased ease in removal of the grip device 10 from the container 11. For example, a user's foot may be placed on the outer wall 17 while pulling upwardly on the container 11 to facilitate removal of the container from the grip device 10.

An inner wall 24 illustratively extends upwardly from the inner base portion 15 to define a container receiving opening 18 for receiving the container bottom portion 22. The inner wall 24 resiliently couples to the sidewall 23 of the container 11. More particularly, the inner wall 24 fits snuggly and tightly against the container sidewall 23. Additionally, the grip device 10 may stretch when coupled to a container bottom portion 22 and gripping may be provided by the elastic and resilient properties of the soft rubber.

The inner wall 24 illustratively joins to the outer wall 17 at adjacent upper ends thereof. An upper portion of the inner wall 24 defines a radial notch 25 to facilitate coupling with the container 11. The notch 25 advantageously provides a larger opening at the upper portion of the inner wall 24 for increased ease in inserting the bottom portion 22 of the container 11 into the container receiving opening 18.

The inner base portion 15 includes a radially inwardly extending lip 27 that extends transversely from the inner base portion or radially inward to engage the container bottom portion 22. The inner base portion radially inwardly extending lip 27 illustratively extends inward across a portion of the container bottom portion 22 to define the central base opening 12. This advantageously reduces the weight of the grip device 10 and the amount of materials needed for production, as compared to not having the central base opening 12, and thus reduces the overall production cost of the grip device.

The inner base portion 15 may advantageously be shorter than the outer base portion 14 with respect to the supporting surface 35. In one embodiment, the inner base portion 15 is 0.03 inches shorter than the outer base portion 14. In other words, the inner base portion 15 may be sized such that it does not come in contact with the supporting surface 35, for example, the ground, when the grip device 10 is not coupled to the container 11, or when an empty container is coupled to the grip device. Other dimensions between the inner and outer base portions 15, 14 will be appreciated by those skilled in the art and may be determined by the size of the container, or other factors, for example.

Once the grip device 10 is coupled to a weighted container, the inner base portion 15 also contacts the adjacent or supporting surface 35 and advantageously cooperates with the outer base portion 14 and the slotted base opening 16 therebetween. This arrangement provides increased stability by forming a suction grip on the supporting surface 35.

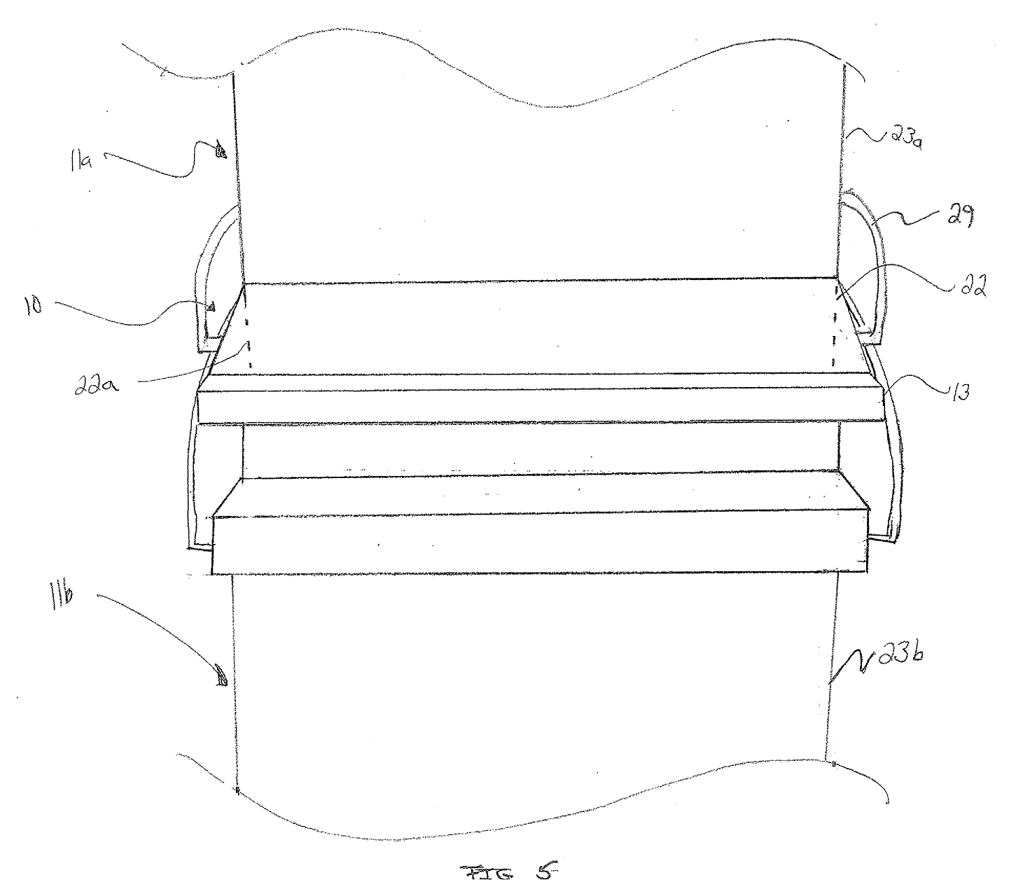

Referring now additionally to FIG. 5, the grip device 10 may also be advantageously positioned on a top portion 31 of a container 11a. The outer base portion 14 includes a radially inwardly extending lip 32, as illustrated more particularly in FIG. 2, for example. The outer base portion radially inwardly extending lip 32 engages a top edge lip 33 of the container 11a. A bottom portion of a second container 11b engages the grip device 10, similar to the configuration as illustrated in FIG. 1, for example, and as described above. This configuration advantageously allows two containers 11a, 11b to be stacked without a lid, as illustrated in FIG. 5.

An insert (not shown) may be removably coupled in the central opening 12 to provide a lid for the container 11. Additionally, in other embodiments, a folding wire handle 29 may be coupled to the grip device 10, to facilitate dumping of the contents of the container 11. A series of circular gripping features 28 may be provided on the outer base portion 14 to provide additional gripping with the supporting surface 35. In some embodiments, the gripping features 28 may not be needed, and in other embodiments the gripping features may be positioned in different locations, or may be different shapes, as will be appreciated by those skilled in the art.

Another aspect is directed to a method of making a grip device 10 useable on a top or bottom portion 31, 22 of a container 11 having a larger top 31 than bottom portion 22. The grip device, when positioned on the bottom portion 22 of the container 11, reduces slipping with an adjacent surface and, when positioned on the top portion 31 of the container 11, facilitates stacking of containers. The method includes forming a body of resilient material. Forming the body of resilient material includes forming a grip base including spaced apart inner and outer base portions 15, 14 to define a slotted base opening 16 therebetween being sized to resiliently engage the top portion 31 of the container 11. Forming the body of resilient material also includes forming an outer wall 17 extending upwardly from the outer base portion 14, and forming an inner wall 24 extending upwardly from the inner base portion 15 to join with the outer wall adjacent upper ends thereof. The inner wall 24 is formed to define a container receiving opening 18 to resiliently engage the bottom portion 22 of the container 11.

The inner wall 24 is formed to define a notch 25. The method also includes forming the inner base portion 15 to include an radially inwardly extending lip 27 that extends perpendicularly from the inner base portion or radially inward to engage the container bottom portion 22. The method further includes forming a radially inwardly extending lip 32 on the outer base portion 14 for engaging a top portion 31 of the container 11. Of courses other methods are also contemplated by the present invention based upon the grip device described herein.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed:

1. A grip device useable on a top or bottom portion of a container having a larger top than bottom portion; the grip device, when positioned on the bottom portion of the container, reducing slipping with an adjacent surface and, when positioned on the top portion of the container, facilitating stacking of containers, the grip device comprising:
a body of resilient material comprising
a grip base including spaced apart inner and outer base portions defining a slotted base opening therebetween being sized to resiliently engage the top portion of the container,
an outer wall extending upwardly from said outer base portion, and
an inner wall extending upwardly from said inner base portion and joining with said outer wall adjacent upper ends thereof, said inner wall defining an opening to resiliently engage the bottom portion of the container.

2. The grip device according to claim 1 wherein said body of resilient material comprises a monolithically formed body of resilient material.

3. The grip device according to claim 1 wherein said outer base portion extends downwardly beyond said inner base portion from the upper portion of the grip device.

4. The grip device according to claim 1 wherein said outer base portion comprises a radially inwardly extending lip for engaging the container top portion.

5. The grip device according to claim 1 wherein said inner base portion comprises a radially inwardly extending lip for engaging the container bottom portion.

6. The grip device according to claim 1 further comprising a handle coupled to said outer base portion.

7. The grip device according to claim 1 wherein said inner wall has a radial notch defined therein at the upper end thereof.

8. The grip device according to claim 1 further comprising a plurality of gripping features on said outer base portion.

9. A grip device useable on a top or bottom portion of a container having a larger top than bottom portion; the grip device, when positioned on the bottom portion of the container, reducing slipping with an adjacent surface and, when positioned on the top portion of the container, facilitating stacking of containers, the grip device comprising:
a monolithically formed body of resilient material comprising
a grip base including spaced apart inner and outer base portions defining a slotted base opening therebetween being sized to resiliently engage the top portion of the container,
an outer wall extending upwardly from said outer base portion, and
an inner wall extending upwardly from said inner base portion and joining with said outer wall adjacent upper ends thereof, said inner wall defining an opening to resiliently engage the bottom portion of the container,
said outer base portion extending downwardly beyond said inner base portion from the upper portion of the grip device.

10. The grip device according to claim 9 wherein said outer base portion comprises a radially inwardly extending lip for engaging the container top portion.

11. The grip device according to claim 9 wherein said inner base portion comprises a radially inwardly extending lip for engaging the container bottom portion.

12. The grip device according to claim 9 further comprising a handle coupled to said outer base portion.

13. The grip device according to claim 9 wherein said inner wall has a radial notch defined therein at the upper end thereof.

14. The grip device according to claim 9 further comprising a plurality of gripping features on said outer base portion.

15. A method of making a grip device useable on a top or bottom portion of a container having a larger top than bottom portion; the grip device, when positioned on the bottom portion of the container, reducing slipping with an adjacent surface and, when positioned on the top portion of the container, facilitating stacking of containers, the method comprising:
forming a body of resilient material comprising
forming a grip base including spaced apart inner and outer base portions to define a slotted base opening therebetween being sized to resiliently engage the top portion of the container,
forming an outer wall extending upwardly from the outer base portion, and
forming an inner wall extending upwardly from the inner base portion to join with the outer wall adjacent upper ends thereof, the inner wall being formed to define an opening to resiliently engage the bottom portion of the container.

16. The method according to claim 15 wherein forming the body of resilient material comprises integrally forming the body of resilient material as a monolithic unit.

17. The method according to claim 15 wherein the outer base portion extends downwardly beyond the inner base portion from the upper portion of the method.

18. The method according to claim 15 wherein forming the outer base portion comprises forming a radially inwardly extending lip for engaging the container top portion.

19. The method according to claim 15 wherein forming the inner base portion comprises forming a radially inwardly extending lip for engaging the container bottom portion.

20. The method according to claim 15 further comprising coupling a handle to the outer base portion.

21. The method according to claim 15 wherein the inner wall is formed to have a radial notch defined therein at the upper end thereof.

22. The method according to claim 15 further comprising forming a plurality of gripping features on the outer base portion.
